(19) United States
(12) Patent Application Publication
(10) Pub. No.: US 2012/0285541 A1
(43) Pub. Date: Nov. 15, 2012

(54) FOUR VALVE DOUBLE VENT TRANSMITTER MANIFOLD

(76) Inventor: Peter B. Hutton, Houston, TX (US)

(21) Appl. No.: 13/446,826

(22) Filed: Apr. 13, 2012

Related U.S. Application Data
(60) Provisional application No. 61/475,081, filed on Apr. 13, 2011.

(51) Int. Cl. F16K 24/04; F16K 11/22

(52) U.S. Cl. 137/1; 137/597; 137/197

(57) ABSTRACT

The manifold of the invention is designed to vent respective high and low pressure sources of fluid pressure from beneath the foils of a pressure transmitter and directing the vented fluid, respectively, through high and low pressure passageways to high and low pressure vents of the manifold. In a preferred embodiment of the invention, the manifold has a primary and a secondary vent valve for each of the high and low pressure passageways through the manifold. A method of venting the manifold is also described.

### CROSS-REFERENCE TO RELATED APPLICATIONS

This application is a U.S. non-provisional application claiming the benefit of U.S. provisional patent application Ser. No. 61/475,081, filed Apr. 13, 2011, the entire content of which is herein incorporated by reference in its entirety.

### BACKGROUND OF THE INVENTION

1. Field of the Invention

The present invention relates to manifolds for connection to a pressure transmitting instrument, e.g., a differential pressure transmitter. The transmitters in use today have membranes or “foils” upon which the fluid impinges. If the foils contain compressible fluids, such as trapped gasses in a liquid, the quality of pressure measurement may be adversely affected. Thus, there exists a need to vent trapped gasses, or other contaminants, from the space adjacent the transmitter foils. The present manifold is designed to vent respective high and low pressure sources of fluid pressure from beneath the foils of a transmitter and directing the vented fluid, respectively, through high and low pressure passageways to high and low pressure vents of the manifold. In a preferred embodiment of the invention, the manifold has a primary and a secondary vent valve for each of the high and low pressure passageways through the manifold. In a most particularly preferred embodiment of the invention, the manifold has a thickness which is relatively small in comparison to either its length, or its width.

2. Description of the Related Art

Various manifolds have been developed to transmit a source of pressurized fluid through a passageway for distribution. An example of one such manifold is described in my previous U.S. Pat. No. 5,277,224, incorporated in its entirety, by reference. However, in such prior manifolds, there may be no, or at most one, vent valve for each of the fluid passageways. Such prior art manifolds may thus develop leaks permitting the fluid, which in some cases is toxic, explosive, flammable, or otherwise hazardous to workers and/or the environment, to escape the manifold.

The present invention avoids the potential for leakage of process fluid from the manifold into the environment.

### SUMMARY OF THE INVENTION

In one embodiment, the invention provides a flat manifold having a first face containing a high and a low pressure vent from the manifold body and a second, and opposing, face having a high and a low pressure transmitter connection. The respective high pressure transmitter connection and vent are fluidly connected by a passageway which is controlled by two vent valves connected in series. The respective low pressure transmitter and vent are also fluidly connected by a separate passageway through the manifold body, which passageway is fluidly controlled by two vent valves connected in series.

In another embodiment of the invention, the manifold body design presents two opposing faces, a first face having an opening for a high pressure input and an opening for a low pressure input and a second face having an opening for a high pressure output and an opening for'a low pressure output. The first and second faces are separated by the manifold body which is defined between the first and second faces and by a peripheral edge connecting the first and second faces. The height of the peripheral edge is much smaller in dimension than the length or width of either the first or second faces. Four valves are mounted on the peripheral edge. In preferred embodiments, the peripheral edge contains at least two chamfered portions and one vent valve is mounted on one of the at least two chamfers.

These and other embodiments of the invention will be better understood when read in light of the appended drawings and the following detailed description of the invention.

### BRIEF SUMMARY OF THE DRAWINGS

FIG. 1 is a schematic representation of the fluid flow paths through the manifold of the invention;

FIG. 2 is a schematic representation of a top view of the manifold of the invention;

FIG. 3 is a bottom view of the manifold of. FIG. 2, having four vent valves in dotted lines to show the environment of the manifold;

FIG. 4 is a front view of the manifold (partially cross-sectioned to show details of the interior passageways through the manifold body);

FIG. 5 is a back view of the manifold of FIG. 2;

FIG. 6 is a right side view of the manifold of FIG. 2 (the left side view (not shown) being a mirror-image of the right side view).

### DETAILED DESCRIPTION OF THE INVENTION

FIG. 2 illustrates the manifold 10 of the invention, wherein the manifold body 12 is defined by a second face 14, having a high pressure transmitter opening 15 and a low pressure transmitter opening 16 in the second face 14. A series of throughbores 17, 18, 19 and 20 exist through manifold body 12 for the purpose of receiving bolts (not shown) or other fasteners to join manifold 10 to other apparatus, such as a pressure transmitter (not shown).

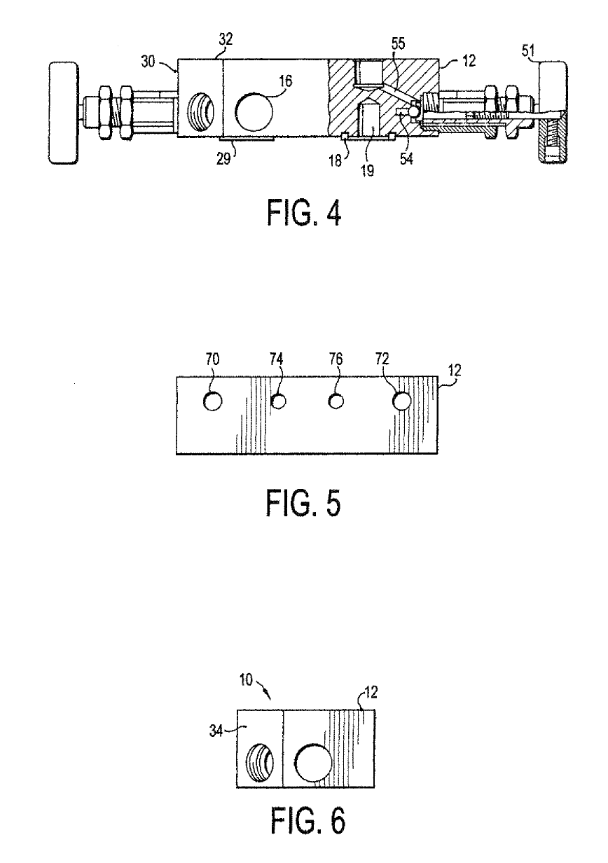

The throughbores 17, 18, 19 and 20 can be seen in FIG. 4 exiting a first face 24 of manifold body 12. First face 24 also contains a high pressure vent 25 and a low pressure vent 26.

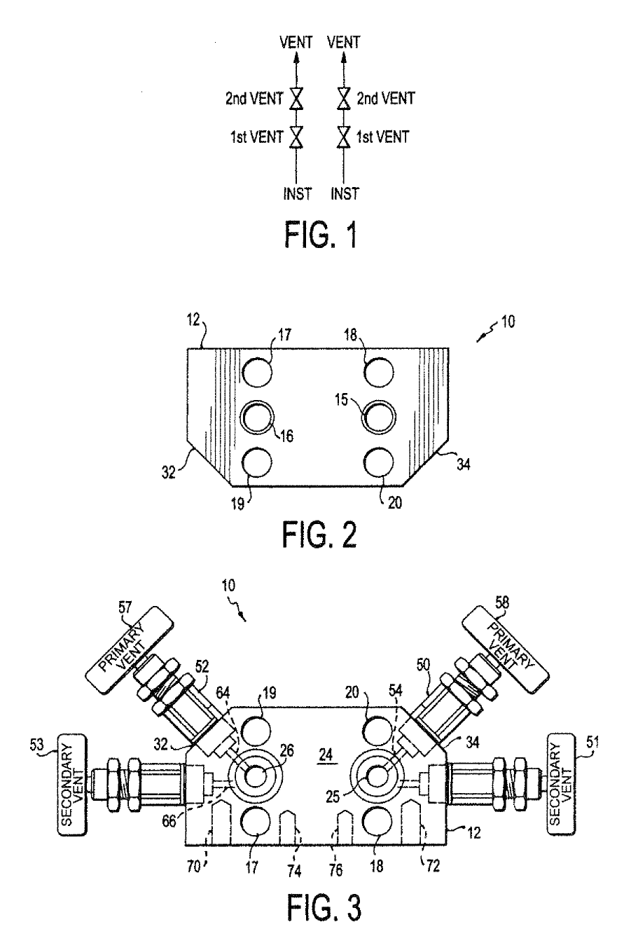

As shown in FIG. 1, the fluid flow paths between the transmitter high pressure and low pressure openings and the respective vents are shown.

Turning to the partially sectioned portion of manifold body 12 shown in FIG. 3, the flow passageway of the high pressure transmitter opening 15 is provided with a polytetrafluoroethylene (available under the trademark TEFLON) or similar seal 19 to prevent leakage between the pressure transmitter (not shown) and the manifold body 12. A similar seal 29 can be provided for low pressure opening 16.

A peripheral edge 30 joins the first face 24 and second face 14 to define manifold body 12 therebetween. At least two chamfers 32, 34 are provided on peripheral edge 30 in order to mount vent valves.

In order to appreciate the environment in which manifold 10 may be used, two primary vent valves 50, 52 and two secondary vent valves 51, 53 are shown in FIG. 4.

Turning to FIG. 3, it can be seen that secondary vent valve 51 is fluidly connected to high pressure vent passageway 55 in order to close, or open the vent passageway upon actuation of secondary valve 51. This will permit the flow of fluid to vent 15.

Similarly, FIG. 4 shows the connection of primary vent valve 50 to passageway 54 which can be opened or closed by operation of primary vent valve 50.

Corresponding low pressure primary vent valve 52 and secondary vent valve 53 can also open and close the low pressure passageways 64 and 66 (partially hidden) in FIG. 4.

Although in the embodiment shown in FIG. 3, the primary vent valves 50 and 52 are shown mounted on chamfers 34 and 32, respectively, the internal passageways could be designed such that secondary valves are mounted on the chamfers. The existence of chamfers 32, 34 permits more room for access to the valve bonnets 58, 57 by an operator to manipulate the valve opening and closing cycle.

As shown in FIG. 5, mounting holes 70, 72, which could accept a ⅜ inch fastener (not shown) or mounting holes 74, 76 to accept a ¼ inch fastener (not shown) to mount the manifold body 12 to a support (not shown) can be provided for ease of mounting the manifold body 12. Such holes 70, 72, 74, 76 are shown in dotted line as these features are not essential to the disclosed embodiments of the invention and are merely illustrated to show the environment of the invention.

A method of venting the manifold is also within the scope of the invention. The method of venting the manifold comprises providing a manifold body defining passageways therein, and vent valves controlling fluid flow in the passageways; the passageways comprising at least one of high and low pressure pasasageway in the manifold body; providing at least a primary and secondary vent valve connected in series in at least one of the high and low pressure passageways; opening the primary vent valve in at least one of the at least high and low pressure passageways to direct the flow of any trapped gasses or contaminants towards said secondary vent valve; and, opening said secondary vent valve in the same passageway as said primary vent valve to discharge the flow from the manifold. In a particularly preferred embodiment of the method, the primary vent valve is opened, directing the flow of gasses and/or contaminants through the passageway towards the secondary vent valve, the primary valve is closed, and the secondary vent valve is opened, venting the gasses and/or contaminants from the manifold body. The vented gasses and/or contaminants can be collected in any suitable vessel (not shown). The operation of opening and closing the primary and secondary vent valves may be repeated a number of times until all the contaminants and/or trapped gasses are vented.

Having fully described my invention, it will be obvious to those skilled in the art, upon reading this disclosure in light of the appended drawings, that many modifications can be made without departing from the spirit and scope of the invention herein disclosed.

I claim:

1. A manifold comprising a manifold body defining passageways therein, and vent valves controlling fluid flow in the passageways;
the manifold body defined by opposing first and second faces, which first and second faces are connected by a peripheral edge;
the second face having a high pressure and a low pressure opening fluidly connected to respective high pressure and low pressure vents in a first face, by respective high and low pressure pasasageways in the manifold body;
at least a primary and secondary vent valve connected in series in each of the high and low pressure passageways.

2. The manifold of claim 1, wherein the peripheral edge comprises at least two chamfered portions.

3. The manifold of claim 2, wherein said primary vent valve is located on at least one of said at least two chamfered portions.

4. The manifold of claim 2, wherein said secondary vent valve is located on at least one of said at least two chamfered portions.

5. The manifold of claim 1, wherein said second face comprises the high and low pressure outlets shaped to mate with a pressure transmitter.

6. The manifold of claim 5, in combination with a pressure transmitter.

7. The manifold and transmitter combination according to claim 6, further comprising a seal between said second face and said pressure transmitter.

8. The manifold of claim 5, wherein said first face further comprises high and low pressure inlets.

9. The manifold of claim 1, wherein the height of the peripheral wall is smaller than either the length or width than either of the opposing first and second faces.

10. The manifold of claim 1, wherein four valves are mounted on the peripheral edge.

11. The manifold of claim 7, wherein the seal comprises polytetrafluoroethylene.

12. A method of venting a space between a manifold a pressure transmitter connected to said manifold; the method comprising:
providing a manifold body defining passageways therein, and vent valves controlling fluid flow in the passageways;
the passageways comprising at least one of high and low pressure pasasageway in the manifold body;
providing at least a primary and secondary vent valve connected in series in at least one of the high and low pressure passageways;
opening the primary vent valve in at least one of the at least high and low pressure passageways to direct the flow of any trapped gasses or contaminants towards said secondary vent valve; and,
opening said secondary vent valve in the same passageway as said primary vent valve to discharge the flow from the manifold.

13. The process of claim 12, wherein the primary vent valve is closed before the secondary vent valve is opened.

14. The process of claim 12, wherein the passageway being vented is the high pressure passageway.

15. The process of claim 12, wherein the passageway being vented is the low pressure passageway.

16. The process of claim 12, wherein the passageway being vented is located on a face of the manifold in which an inlet of the same passageway is located.

17. The process of claim 13, further comprising repeating the steps of opening and closing the primary and secondary vent valves.

18. The process of claim 12, further comprising collecting the flow vented from the manifold.

19. The process of claim 12, wherein each of the high and low pressure passageways are vented.

20. The process of claim 17, wherein each of the high and low pressure passageways are vented.
